(19) United States
(12) Patent Application Publication
(10) Pub. No.: US 2023/0142895 A1
(43) Pub. Date: May 11, 2023

(54) CODE-TO-UTILIZATION METRIC BASED CODE ARCHITECTURE ADAPTATION

(71) Applicant: AT&T Intellectual Property I, L.P., Atlanta, GA (US)

(72) Inventors: Andrew Campbell, Pleasant Hill, CA (US); Shreyash Taywade, McKinney, TX (US); Prince Paulraj, Coppell, TX (US)

(21) Appl. No.: 17/520,144

(22) Filed: Nov. 5, 2021

(51) Int. Cl. G06F 9/50; G06F 11/34; G06F 11/07

(52) U.S. Cl. CPC G06F 9/505; G06F 11/3433; G06F 11/0709

(57) ABSTRACT

Determining a recommendation to convert a block of code into a serverless function based on analysis of code in execution in a cloud computing environment is disclosed. The block of code can be correlated to high levels of computing resource utilization that can inflate a cost of deploying a corresponding application in the cloud computing environment by prophylactically increasing an amount of provisioned computing resources to accommodate the high-utilization of the block of code. Converting the block of code into a serverless function can reduce the cost via offloading the functionality from the code into a function call supported by the cloud computing environment in an as-needed capacity, thereby reducing the amount of prophylactically provisioned computing resources. The recommendation can occur continuously in a production environment and cot-to-utilization information can render to facilitate identification of code block conversion targets.

### TECHNICAL FIELD

The disclosed subject matter relates to analysis of code in execution, and corresponding computing resource utilization, to determine an adaptation of a code architecture.

### BACKGROUND

Conventionally, entities can overpay for deployment of applications via a ‘cloud computing’ environment, e.g., an available-on-demand computing resource(s) that is typically without direct active management by the entity and generally have functions distributed over multiple locations and share resources between these multiple locations to achieve economies-of-scale. A cloud computing environment can typically use a pay-as-you-go business model to aid in reducing customer-entity expenses. However, overpaying for deployment of applications via a ‘cloud computing’ environment can often be due to the different system design paradigms where a system administrator can seek to avoid over utilization by provisioning a virtual machine(s) (VMs) based on a maximum expected utilization, e.g., buying for maximum utilization even where the system may not regularly operate in the maximum utilization regime. This can lead to systems that are chronically underutilized because they have been provisioned for intermittent bursts of high utilization, which can often lead to costs that can be an order-of-magnitude more than if the VMs are provisioned based on non-peak utilizations of the system. Where a non-peak utilization is used in conventional systems, this can lead to overburdening of the deployed cloud application where a peak utilization occurs. Accordingly, conventional systems generally continue to provision, and pay, for many more cloud resources than they may actually use in non-peak states.

### BRIEF DESCRIPTION OF DRAWINGS

FIG. 1 is an illustration of an example system that can facilitate code architecture adaptation based on a code-to-utilization metric, in accordance with aspects of the subject disclosure.

FIG. 2 is an illustration of an example system that can facilitate determining a code-to-utilization metric based on monitoring of code in execution, in accordance with aspects of the subject disclosure.

FIG. 3 is an illustration of an example system that can enable determining a code-to-utilization metric for a production environment via determining time injection information, in accordance with aspects of the subject disclosure.

FIG. 4 illustrates an example system that can facilitate code architecture adaptation based on a code-to-utilization metric via determining recommendation information for a function that can be a candidate for conversation to a serverless function, in accordance with aspects of the subject disclosure.

FIG. 5 illustrates an example system that can facilitate code architecture adaptation based on determining a candidate serverless function corresponding to a code-to-utilization metric and code embedding information, in accordance with aspects of the subject disclosure.

FIG. 6 is an illustration of an example method, enabling code architecture adaptation based on rendering a code-to-utilization metric to facilitate identifying a function that can be a candidate for conversation to a serverless function, in accordance with aspects of the subject disclosure.

FIG. 7 illustrates an example method, facilitating enabling code architecture adaptation based on a code-to-utilization metric determined in part from time injection information to facilitate identifying a function that can be a candidate for conversation to a serverless function, in accordance with aspects of the subject disclosure.

FIG. 8 illustrates an example method, enabling code architecture adaptation based on a code-to-utilization metric determined in part from time injection information to facilitate identifying a function that can be a candidate for conversation to a serverless function, wherein the time injection information can be verified based on deep code trace information, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional entities can overpay for deployment of applications via a cloud computing environment, hereinafter generally referred to as a cloud comprising a cloud component. It is noted that the disclosed subject matter can function in a cloud, but is typically not directly related to the hardware or architecture of the cloud itself, e.g., the disclosed subject matter can typically be functional with any cloud, e.g., a cloud provided by a third-part cloud computing entity, etc. Rather than, as noted previously, overpaying for deployment of applications via a cloud can often be due to a system administrator over provisioning a virtual machine(s) to avoid deterioration of performance under an expected, but generally intermittent, maximum expected utilization, the presently disclosed subject matter can provide for adapting functions of a system moved to a cloud, e.g., modifying a function architecture of the system deployed on a cloud to enable provisioning of fewer computing resources, but allowing functions that intermittently maximize utilization to be moved to ‘serverless functions’ that can be scaled on demand by a cloud provider. In some embodiments, the term function can be inclusive of more than one function, a block of code, blocks of code, etc., and the term function/functions is intended to be inclusive of code that can be more broad than just a single function even where not explicitly recited for the sake of clarity and brevity. This can avoid needing to buy for maximum utilization even where the system may not regularly operate in the maximum utilization regime, which can avoid systems that are chronically underutilized. Analysis of code in execution and corresponding computing resource utilization, as disclosed herein, can be performed in a production environment such that functions causing peak-utilization conditions can be recommended for adaptation, e.g., into a serverless function, that can be instantiated by the cloud provider on an as-needed basis. Peak-utilization functions, as is disclosed herein, can therefore be excluded from provisioning of more general computing resources by being shifted into an on-demand provisioning, e.g., as a function as a service (FaaS), as a serverless function, etc. Accordingly, in comparison to conventional systems, the disclosed subject matter can more efficiently employ cloud services for deployment of applications, which can result in lower deployment and operational costs.

A function-as-a-service (FaaS) can be provided via a cloud-computing service and can support execution of FaaS code that can be responsive to events while avoiding implementation of complex infrastructure features that can more typically be associated with developing and implementing an application feature. Generally, a software application hosted on a cloud, e.g., on an internet server, etc., typically can require provisioning and management of a virtual or physical server, managing an operating system, managing web server hosting processes, etc. However, a FaaS function can be deployed, scaled, and managed by a cloud provider, e.g., physical hardware, a virtual machine, web server software, etc., associated with a FaaS function can all be delegated to a cloud service provider that can perform, manage, scale, etc., these components automatically on behalf of a client application. A serverless function can be a FaaS function. A serverless function is typically focused on a service category, e.g., a serverless function can be tailored to computation, storage, database, messaging, application programming interface (API) gateways, etc., where configuration, management, and billing of servers can then be invisible to an end user, e.g., a client application running in the cloud. FaaS functions generally can be considered to encompass serverless functions while typically being considered by those in the art to be more focused on an event-driven computing paradigm wherein application code, or containers, run in response to events or requests. As such, serverless functions are generally considered to be part of the broader FaaS environment.

Serverless functions, like other FaaS functions generally are considered to be beneficial when migrating applications to a cloud, e.g., a serverless function can be scaled automatically and independently by a cloud provider, removing this burden from an application developer. This can be significant where modification of an application to scale a function can often be associated with rebuilding the application on a cloud component rather than the cloud provider triggering a serverless function in a scalable manner, e.g., a serverless function can avoid costly and time-consuming modification of application code by moving parts of application code into a serverless function that can be provisioned, managed, scaled, etc., by a cloud provider. It is noted that converting a code block to a serverless function does inherently require restructuring of code, however this restructuring is to be considered acceptable where a serverless function can be then called, managed, scaled, etc., separately from the code modified to remove the corresponding block of code now converted to a serverless function, e.g., the modification of application code to remove a code block that has been converted to a serverless function can generally be less demanding than updating application code retaining a code block, especially where the application code is scaled, etc. Moreover, as a serverless function can be called on-demand, there is no need to provision more computing resources than are needed to execute the application code without the functionality of the code moved into a serverless function, e.g., rather than anticipatorily provisioning computing resources for high-utilization code that is occasionally executed, the high-utilization code can be moved into a serverless function that can be called on-demand and can alleviate the need to anticipatorily provision corresponding computing resources. This can lower the cost of moving an application into the cloud. An issue with developing serverless functions can be understanding what blocks of application code are high-utilization code, more especially high-utilization code that is executed in bursts that can be very resource demanding, and which blocks are not high-utilization code. The disclosed subject matter can provide for rendering of code-to-utilization information that can aid in understanding what blocks of code can be candidates for implementation via a serverless function(s). The concept of a serverless function itself, as is known in the arts, is less useful where there is a poor understanding of what code blocks actually correspond to high computing resource utilization states, and automating identification of high-utilization code can provide great benefit over, for example, manual identification of such code blocks.

In this regard, appreciation of high computing resource utilization state, e.g., identifying a high-utilization function, etc., in regard to code in execution in a production environment, as compared to tooling of application code in development, can therefore be of considerable value. The disclosed subject matter presents determining time injection information (timeinfo) that can be performed in a production environment and can be distinct from conventional deep code tracing, e.g., via a code profiling component, etc., that generally is not suitable for a production environment. Code profiling can more conventionally comprise instrumenting program source code, corresponding binary executable code, etc., via a profiling tool, hereinafter a profiler, code profiler, etc. Profilers can employ techniques, such as, event-based, statistical, instrumented, simulation methods, etc., to measure application code performance, e.g., space/memory, time complexity, calling particular instructions, a frequency/duration of a function call, etc. Conventional profiles techniques can implement hardware interrupts, code instrumentation, instruction set simulation, operating system hooks, performance counters, or other invasive tooling of application code that, while useful in a development environment, are generally not practical in a production environment. The disclosed subject matter can, in contrast, create detailed logs identifying which blocks of code are running at a given time stamp, e.g., as timeinfo via a time log injection component, e.g., timeinfo component 340, etc. Timeinfo component 340, for example, can be a tool that can be said to ‘decorate’ or ‘wrap’ raw source code and can automatically inject a time logging statement, for example, ‘aspect oriented programming’ (AOP), etc. This avoids the tooling of sources code by an application owner that is typically associated with conventional code profiling tools. Timeinfo can be run continuously, e.g., in a production environment, etc., as opposed to the traditional profilers that can cause considerable compute overhead and are generally run as a one-off application code study. Timeinfo can be combined with computing resource utilization information (utilinfo) for generation of code-to-utilization information (ctuinfo). An example of rendering of ctuinfo can be a plot computing resource utilization in a vertical axis against a horizontal time axis to give a running visualization of resource utilization that can readily indicate a period of high utilization. In an embodiment, rendering of ctuinfo can be performed via a ctuinfo dashboard application to enable a user to interact with ctuinfo, e.g., visualizing ctuinfo, selecting portions of ctuinfo, zooming in, zooming out, determining a ctuinfo statistic/value/range, or other typically data dashboard type interactions that are considered within the scope of the present disclosure but are not enumerated for the sake of clarity and brevity. This above example period of high utilization can be correlated to a corresponding historical code block execution via timeinfo, whereby high-utilization code can be readily identified.

Additionally, the disclosed subject matter can support determining code embedding information (embinfo) that can group code blocks in multidimensional space. Accordingly, embinfo can facilitate determining code blocks that can have similar behaviors and/or functionality by collocating them near each other in an embedding space that can be a high-dimensional continuous space of points for mapping blocks of source code, wherein high-dimensional can indicate that the embedding space has at least a plurality of dimensions, though typically many dimensions, and can sometimes be referred to as a ‘k-dimensional space.’ An identified high-utilization code block can be identified in the embedding space to enable identification of neighbor code blocks in the embedding space. As such, high-utilization code blocks that have many close embedding space neighbors can be preferred candidates for conversion to a serverless function, particularly where the serverless function can capture functionality of close embedding space neighbors. In an example, a first high-utilization code block can have an embedding space neighbor code block and a single serverless function can replace both the first high-utilization and neighbor code block. This can be a more efficient use of application developer time than, for example, failing to identify the neighboring code block and instead developing two serverless functions that, according to the embedding space can have similar behaviors and functionality. Embinfo can be based on creation of numerical representations of source code modules/blocks that can be used for clustering and identification of functionally similar blocks of code in the high-dimensional continuous embedding space.

In some embodiments, conventional deep code trace information (deepinfo) can be employed in verifying timeinfo is sufficiently accurate. In this regard, application code can be instrumented, tooled, etc., and a conventional code study can be performed to generate deepinfo that can then be compared to the novel timeinfo disclosed herein. Where deepinfo and timeinfo are insufficiently cohesive, determining timeinfo can be modified to correct the lack of adequate cohesion between the deepinfo and timeinfo, e.g., deepinfo can be used as a standard against which timeinfo determination can be adjusted to allow timeinfo to be used as a sufficiently accurate stand-in for deepinfo in a production environment in which deepinfo is generally not practical to determine. Deepinfo can also be employed to train, update, augment, etc., an architecture recommendation engine, e.g., recommendation component (RECC) 520, etc. Similarly, a conventional computing resource logging component can generate computing resource utilization information (utilinfo) that can be employed to train, update, augment, etc., an architecture recommendation engine, e.g., recommendation component (RECC) 520, etc. Utilinfo can also be employed in determining ctuinfo. In some embodiments, utilinfo can be determined by a VM information (vminfo) component, such as vminfo component 306, etc. In this regard, utilinfo and vminfo can be the same information in some embodiments, e.g., utilization of computing resources can be consumed in determining timeinfo, for example as illustrated in system 300, etc., and this same vminfo, or alternatively separately determined utilinfo, can be employed by an analysis component, for example, vminfo 306 can be consumed by timeinfo component 340 and utilinfo 309 can be consumed by analysis component 310 as illustrated in system 300. However, in a variation of this example embodiment, utilinfo 309 can be substituted with vminfo 306 in some embodiments, although not illustrated in system 300 for the sake of clarity and brevity.

In embodiments, a recommendation of a code block that can be a candidate for conversion to a serverless function can be based on one or more of ctuinfo, embinfo, deepinfo, etc. As noted elsewhere herein, ctuinfo can facilitate identifying a code block associated with high utilization of computing resources. Embinfo can facilitate identifying a neighboring code block(s) that can have similar behavior, functionality, etc. Deepinfo can accurately indicate a high-utilization code block in an application development environment to train an architecture recommendation engine that can then formulate recommendations based on timeinfo that is determined to be sufficiently accurate. An architecture recommendation engine (ARE) can be embodied in RECC 120, 320, 420, 520, etc., and can employ a neural network in determining a recommendation of a candidate code block for conversion to a serverless function. An ARE can output a recommendation that can identify a candidate block of code, an estimated cost savings of converting the candite block to a serverless function for future operations, etc. It is noted that cost savings can be estimated, determined, inferred, etc., from ctuinfo, e.g., by estimating a difference between a code block associated with a peak computing resource utilization and non-peak utilization values, an estimate of the cost of running the code block normally, rather than as a serverless function, can be determined. A neural network of an ARE, in an embodiment, can be a classifier that can predict a likelihood of successfully re-architecting a block of code as a serverless function. This ARE embodiment can include a heuristic that can estimate a cost savings based on the ctuinfo as disclosed herein. In another embodiment, a neural network of an ARE can be a regression model that can predict a total cost savings of migrating a block of code to a serverless function. It is noted that a code block that cannot be migrated or is a poor candidate for migration to serverless format can be identified by a low or negative cost savings prediction. In a further embodiment, a neural network of an ARE can perform unsupervised clustering via an embedding model that can collocate a block of code with similar properties in an embedding space and, in conjunction with ctuinfo, can expressively capture hardware utilization behaviors in a manner that is fundamentally different than purely syntactically defined embedding models. Expert knowledge can be applied to identify clusters of code blocks in an embedding space that can be good candidates for serverless functions, which can enable development of machine learning systems within the scope of the instant disclosure that can identify high-utilization code blocks based on embinfo with less, or no, dependency on ctuinfo, deepinfo, etc. In these embodiments, ctuinfo can similarly be used to estimate cost savings for converting an application code block to a serverless function.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

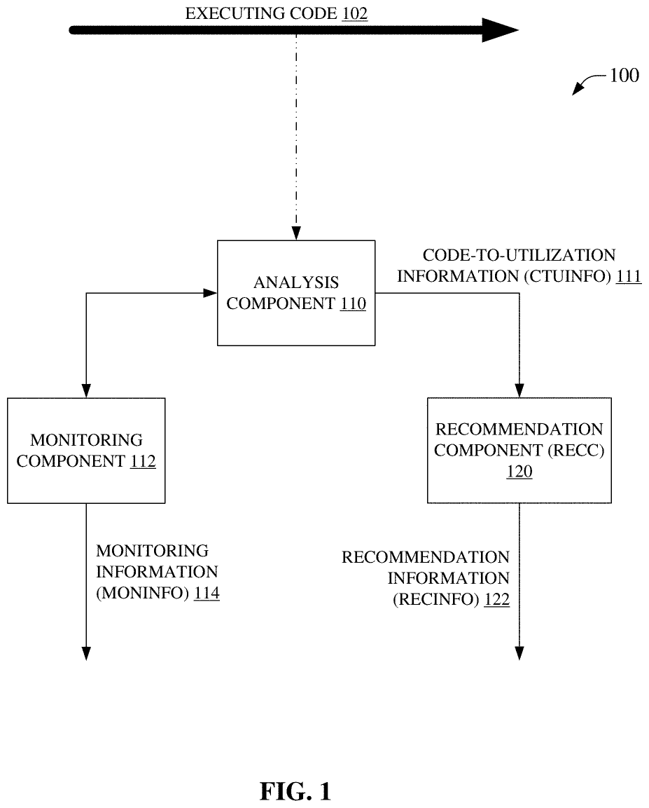

FIG. 1 is an illustration of a system 100, which can facilitate code architecture adaptation based on a code-to-utilization metric, in accordance with aspects of the subject disclosure. System 100 can comprise executing code 102 that can be application source code, or a derivative thereof, that can be executed on processors comprised in a cloud computing environment, e.g., via a virtual machine (VM), server, computing cluster, or other embodiment of a real or virtual cloud computing device. As an example of executing code 102, source code for an application can be compiled into an executable file that can be executed on a VM embodied via a processor of a server comprised in a cloud computing environment. The subject matter disclosed herein is operable in, via, or in conjunction with nearly any cloud computing environment even where not explicitly recited for the sake of clarity and brevity. The executing code 102 can be monitored by analysis component 110, as illustrated by the arrow between executing code 102 and analysis component 110 of system 100. It is noted that any alterations to code architecture based on monitoring of executing code 102, e.g., converting a code block into a serverless function, can be implemented in future embodiments of executing code 102. As such, system 100 can be regarded as monitoring executing code 102, embodied in source code and cloud computing resource utilizations, to determine adaptations of code architecture that can be used at a future time, e.g., a candidate code block can be converted into a serverless function, the code block can be removed from the code, and, as such, future executing code can operate without the code block by calling the corresponding serverless function that can be managed by a cloud computing resource component.

Analysis component 110 can analyze code blocks in execution via cloud computing resources, e.g., executing code 102, and can determine code-to-utilization (ctuinfo) 111. In embodiments, monitoring component 112 can facilitate rendering of ctuinfo 111 via generating monitoring information (moninfo) 114. In an example, moninfo 114 can be displayed as a time-based plot of a level of computing resource utilization, of a total cost of utilization, etc. This example visualization of moninfo 114 can enable a system administrator to view, zoom into, zoom out of, access measurements/values of, etc., portions of ctuinfo corresponding to executing code 102. In an example, the visualization can allow a user to see regions of high computing resource utilization occurring above a background level of computer resource utilization for an applications executing in a cloud environment, which can enable identification of one or more corresponding code blocks relating to the high utilization of the cloud resources.

Ctuinfo 111 can be passed to recommendation component (RECC) 120 that can generate recommendation information (recinfo) 122. Recinfo 100 can embody an indication of a candidate code block that can be considered as a target for conversion to a serverless function. RECC 120 can determine recinfo 122 based on neural network. REC 122 can comprise an embodiment of an architecture recommendation engine (ARE). A neural network can enable determining a recommendation of a candidate code block for conversion to a serverless function. The recommendation can identify a candidate block of code, an estimated cost savings of converting the candite block to a serverless function for further operations, etc., e.g., costs saved by implementing the code block as a serverless function rather than maintain computing resource overhead for the code block before conversion to a serverless function. In embodiments, the neural network can be a classifier that can predict a likelihood of successfully re-architecting a block of code as a serverless function. This ARE embodiment can include a heuristic that can estimate a cost savings based on the ctuinfo as disclosed herein. In other embodiments, the neural network can be a regression model that can predict a total cost savings of migrating a block of code to a serverless function, where a low or negative cost savings prediction can correspond to a code block that is less preferable, or should not be, converted to a serverless function. While in yet other embodiments, the neural network can be an embedding model that can perform unsupervised clustering that can collocate a block of code with similar properties in an embedding space and, in conjunction with ctuinfo, can expressively capture hardware utilization behaviors in a manner that is fundamentally different than purely syntactically defined embedding models. Expert knowledge can be applied to identify clusters of code blocks in an embedding space that can be good candidates for serverless functions. In these embodiments, ctuinfo can similarly be used to estimate cost savings for converting an application code block to a serverless function.

System 100 can illustrate, that executing code 102 can be monitored to enable an analysis, e.g., via analysis component 110, of what code is being executed at a given time and what corresponding computing resource utilization is occurring, e.g., as ctuinfo 111. Information related to the analysis can be rendered via monitoring component 112, e.g., based on moninfo 114, for example as a time-based plot of cloud resource utilization. Accordingly, high-utilization features can be identified. This can enable identification of corresponding code blocks, e.g., what code blocks correspond to high-utilization states. Accordingly, RECC 120 can generate a recommendation, e.g., embodied in recinfo 122, that can indicate a code block that can be a candidate for conversion to a serverless function. Where a code block is converted to a serverless function, the code block can be removed from future iterations of the executing code. As such, future executing code can call the serverless function rather than executing the code block, which can result in provisioning cloud resources more efficiently by not needing to preemptively provision typically less used cloud resources associated with the demand of executing the now removed code block because the replacement serverless function can be called on-demand and managed by the cloud computing environment independent of the application being run on the cloud system.

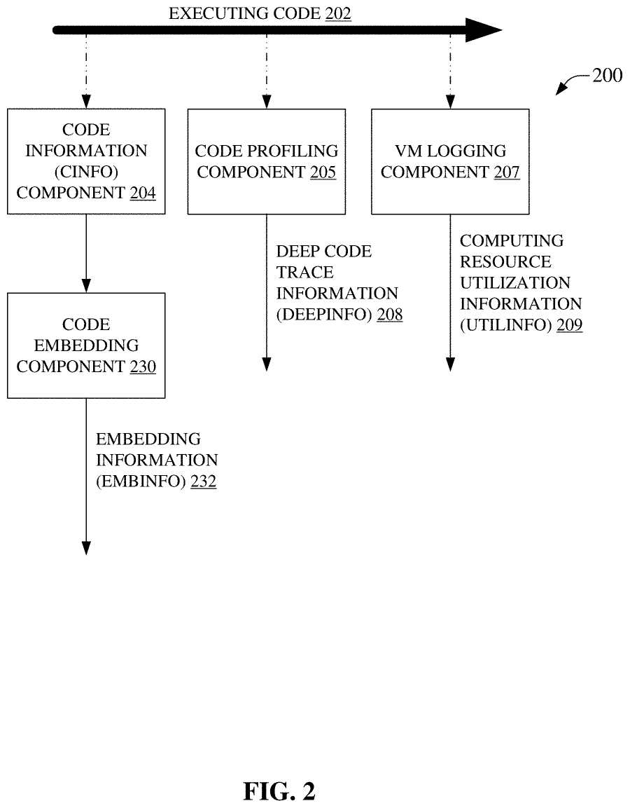

FIG. 2 is an illustration of a system 200, which can enable determining a code-to-utilization metric based on monitoring of code in execution, in accordance with aspects of the subject disclosure. System 200 can comprise one or more components monitoring executing code 202. Executing code 202 can be source code, or derivatives thereof, that can be executing on components of a cloud computing environment, which can be similar to executing code 102 of system 100. Components monitoring executing code 202 can be one or more of code information (cinfo) component 204, code profiling component 205, VM logging component 207, etc.

Cinfo component 204 can monitor executing code 202 to determine the identity of a block of code being executed on a could computing resource. Cinfo component 202 can further determine functionality of an identified code block. Cinfo from cinfo component 204 can be consumed by code embedding component 230. Code embedding component 230 can determine a numerical representation of source code modules/blocks that can be used for clustering and identification of functionally similar blocks of code in a high-dimensional continuous embedding space. As such, embedding information (embinfo) 232 can comprise an indication of groups of code blocks that can be functionally similar. Neighbors of a code block in an embedding space can therefore be selected based on how near they are to the code block, e.g., code blocks with high levels of similarity between their functionality can be closer in the embedding space than code blocks with lower levels of similarity between their functionalities. In this regard, recommendations for converting a code block into a serverless function can be directed to code blocks that can be comprised in more significant groups because the resulting serverless function can then be designed to encompass the functionality of the group of code blocks allowing those code blocks to be replaced in an efficient manner, e.g., designing one serverless function to replace five code blocks with similar functionality in the embedding space can be viewed as being more favorable than designing five serverless functions to replace five code blocks with divergent functionality in the embedding space. However, it is noted that in this regard, where a code block is of sufficiently high-utilization of cloud resources, it can still be preferable to replace that code block even where it can have few or even no embedding space neighbors, notwithstanding favoring replacing high-utilization code blocks that do have neighbors still generally being considered a positive outcome.

Code profiling component 205 can monitor executing code 202 and can generate conventional deep code trace information (deepinfo) 208. Code profiling component 205, in some embodiments, can be a conventional code profiler and can be used to generate conventional deepinfo. As has been noted elsewhere herein, deepinfo can typically be generated in a development environment or testing environment, rather than in a production environment, and deepinfo is generally predicated on instrumenting source code, corresponding binary executable code, etc., via a profiling tool. Code profiling component 205, in some embodiments, can be a profilers that can employ techniques, such as, event-based, statistical, instrumented, simulation methods, etc., to measure application code performance, e.g., space/memory, time complexity, calling particular instructions, a frequency/duration of a function call, etc., and can implement hardware interrupts, code instrumentation, instruction set simulation, operating system hooks, performance counters, or other invasive tooling of application code that, while useful in a development/testing environment, are generally not practical in a production environment. As such, deepinfo 208 can be regarded as being of high quality and truly representative of executing code 202. As such, deepinfo 208 can be used by other components of systems disclosed herein, e.g., to verify timeinfo in system 300, to teach a neural network embodied in RECC 420 of system 400, etc. It is noted that deepinfo 208 can be distinct from timeinfo disclosed elsewhere herein, e.g., via timeinfo component 340, etc. Timeinfo can be much lighter weight than deepinfo 208 and timeinfo can be preferable in a production environment where it is sufficiently accurate. Accordingly, verifying the accuracy of timeinfo against deepinfo 208 can be valuable and can enable timeinfo to be generated and used with confidence in a production environment, e.g., timeinfo can be generated continuously in a production environment, etc., as opposed to deepinfo 208 that can cause considerable compute overhead and can be generally created in one-off application code studies.

System 200 can further comprise VM logging component 207 that can track cloud computing resource utilization. VM logging component 207 can generate computing resource utilization information (utilinfo) 209 reflecting the utilization of cloud computing resources. In some embodiments, utilinfo 209 can be interchangeable with vminfo, e.g., vminfo 306, etc. However, in some embodiments, VM logging component 207 can be a conventional logging component, for example, a logging component application provided by a cloud computing platform. Accordingly, utilinfo 209 can be conventional cloud computing resource log data in some embodiments. As such, in some embodiments, utilinfo 209 can be distinct from vminfo, wherein vminfo can be determined by a VM information component, e.g., vminfo component 306. In these embodiments, a system can comprise both a vminfo component, e.g., 306, etc., and a VM logging component, e.g., 207, etc. In other embodiments, vminfo can be used in lieu of utilinfo 209, for example where a vminfo component 306 is comprised in a system and is selected for use rather than relying on an embodiment of VM logging component 207 provided by a cloud platform. While in other embodiments, utilinfo 209 can be used in lieu of vminfo, for example where a cloud platform provides an embodiment of VM logging component 207 and this component is selected over inclusion of vminfo component 306.

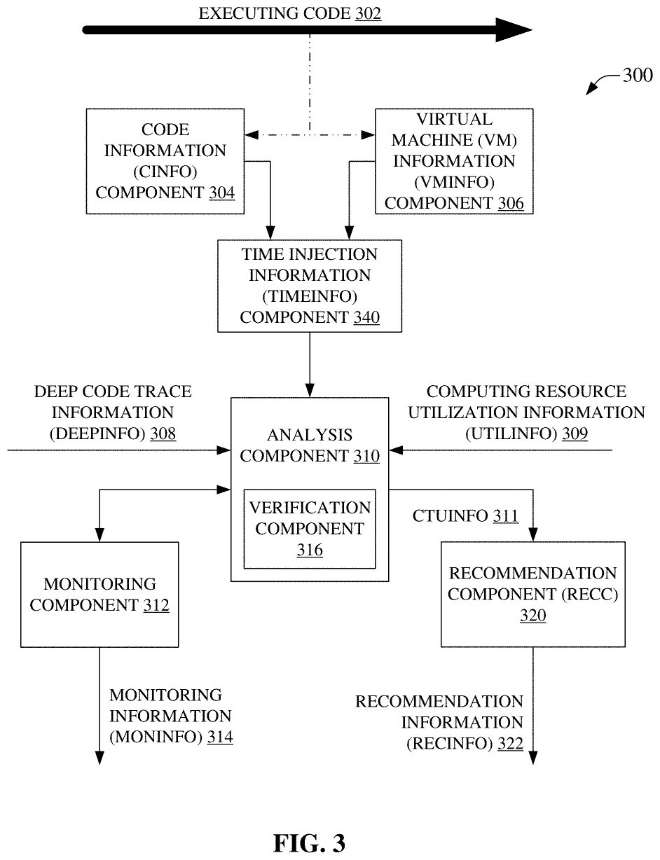

FIG. 3 is an illustration of a system 300, which can facilitate determining a code-to-utilization metric for a production environment via determining time injection information, in accordance with aspects of the subject disclosure. System 300 can comprise executing code 302 that can be application source code, or a derivative thereof, that can be executed on processors comprised in a cloud computing environment, e.g., via a virtual machine (VM), server, computing cluster, or other embodiment of a real or virtual cloud computing device. The executing code 302 can be monitored by components of system 300, as illustrated by the broken-line arrows between executing code 302 and other components of system 300, e.g., cinfo component 304, vminfo component 306, etc.

Cinfo component 304 can monitor executing code 302 and can extract code information (cinfo), e.g., what code blocks are in execution, etc. In this regard, even if executing code 302 is, for example, assembly code in execution, cinfo component 304 can determine which code blocks are being executed at any point in the assembly code, e.g., cinfo component 304 can map any derivative of source code back to the source code to enable identification of code blocks being performed in executing code 302 running on a cloud platform component. Cinfo component 304 can generate cinfo that can be received, as illustrated, by time injection information (timeinfo) component 340.

Vminfo component 306 can also monitor executing code 302. Vminfo component 306 can generate vminfo that can indicate utilization of cloud computing resources, e.g., what cloud computing resources are being used and to what extent they are being used. Vminfo can be communicated from vminfo component 306 to timeinfo component 340, as illustrated. In some embodiments, computing resource utilization information (utilinfo) 309 can be generated, for example by a VM logging component, such as VM logging component 207 of system 200, and can be substituted for, or supplementary to, vminfo from vminfo component 306. Accordingly, where system 300 does not comprise vminfo component 306, utilinfo 309 can be communicated to timeinfo component 340 as a substitute for vminfo. Further, system 300 can use vminfo from vminfo component 306 as a substitute for utilinfo 309 communicated to analysis component 310. In other embodiments, for example as illustrated in system 300, vminfo component 306 can communicate vminfo to timeinfo component 340 and utilinfo 309 can be received from another component, e.g., VM logging component 207, and be received at analysis component 310.

Timeinfo component 340 can receive cinfo and vminfo that can be based on monitoring of executing code 302. Timeinfo component 340 can employ the cinfo and vminfo and inject timing information to create detailed logs identifying which blocks of code are running at a given time stamp in relation to cloud computing resource utilization metrics. This can result in timeinfo, e.g., combining time logs, code information, and utilization information, that can be communicated to analysis component 310. It is noted that, in some embodiments, timeinfo can be determined continuously and in a production environment, whereby it can be distinct from more conventional profiling tools that typically are not employed in production environments due to the instrumentation of code used, and higher levels of computing overhead needed to perform traditional code profiles.

Analysis component 310 can receive timeinfo from timeinfo component 340. Timeinfo can be compared to deepinfo 308 to verify, e.g., via verification component 316, that timeinfo is sufficiently accurate, e.g., deepinfo 308 can be conventional code profiling results that can be accepted as being a most accurate representation of code performance over time. However, where deepinfo 308 is generally not continuously generated in a production environment, it can be preferable to use timeinfo that can be continuously generated in a production environment for determining ctuinfo 311, so long as timeinfo is sufficiently accurate to be relied on for these purposes. Accordingly, verifying timeinfo against deepinfo 308 can provide confidence that timeinfo is sufficiently accurate. Moreover, inaccuracies between timeinfo and deepinfo 308 can result in adjustment of timeinfo component 340 to improve the accuracy of generated timeinfo, e.g., verification component 316 can facilitate updating of timeinfo component 340 based on the verification of satisfactory accuracy of timeinfo in relation to deepinfo 308. Moreover, the verification operation can be performed sufficiently often to provide continued confidence in timeinfo, e.g., verification can be repeated at selected periods, intervals, times, or triggered, for example, by new deepinfo 308 becoming available, etc.

Analysis component can generate code-to-utilization information (ctuinfo) 311 based on timeinfo. In some embodiments, utilinfo 309 can also be employed in determining ctuinfo 311, e.g., utilinfo 309 can be substituted for vminfo where a cloud platform utilization component is selected to provide utilization information. Ctuinfo 311 can be communicated towards recommendation component (RECC) 320. Moreover, analysis component 310 can communicate with monitoring component 312, which can generate moninfo 314 that can be employed to render aspects of ctuinfo, for example, a plot of computing resource utilization in time, wherein selection of portions of the plot can facilitate identification of relevant code blocks that can correspond to levels of resource utilization of interest. In this example, a peak utilization can be ‘selected’ to indicate an identity of the code block(s) executing at the time of the peak utilization.

As noted, ctuinfo 311 can be passed to RECC 320 that can generate recinfo 322. Recinfo 322 can embody an indication of a candidate code block that can be considered as a target for conversion to a serverless function. RECC 320 can determine recinfo 322 based on neural network. A neural network can enable determining a recommendation of a candidate code block for conversion to a serverless function. The recommendation can identify a candidate block of code, an estimated cost savings of converting the candite block to a serverless function for further operations, etc., e.g., costs saved by implementing the code block as a serverless function rather than maintain computing resource overhead for the code block before conversion to a serverless function. In embodiments, the neural network can be a classifier that can predict a likelihood of successfully re-architecting a block of code as a serverless function. This embodiment can include a heuristic that can estimate a cost savings based on the ctuinfo as disclosed herein. In other embodiments, the neural network can be a regression model that can predict a total cost savings of migrating a block of code to a serverless function, where a low or negative cost savings prediction can correspond to a code block that is less preferable, or should not be, converted to a serverless function. While in yet other embodiments, the neural network can be an embedding model that can perform unsupervised clustering that can collocate a block of code with similar properties in an embedding space and, in conjunction with ctuinfo, can expressively capture hardware utilization behaviors in a manner that is fundamentally different than purely syntactically defined embedding models. Expert knowledge can be applied to identify clusters of code blocks in an embedding space that can be good candidates for serverless functions. In these embodiments, ctuinfo can similarly be used to estimate cost savings for converting an application code block to a serverless function.

System 300 can illustrate, that executing code 302 can be monitored. The monitored code can be time logged to enable correlating execution of code blocks with resource utilization, e.g., as timeinfo. Timeinfo can be verified as being sufficiently accurate against deepinfo 308 via verification component 316. Inaccuracies between deepinfo 308 and timeinfo can be corrected for to ensure that timeinfo is sufficiently adequate to be relied on. Time info can then be analyzed, by analysis component 310 indicate what code is being executed at a given time and what corresponding computing resource utilization is occurring, e.g., as ctuinfo 311. Information related to the analysis can be rendered via monitoring component 312, e.g., based on moninfo 314, for example as a time-based plot of cloud resource utilization. Accordingly, high-utilization features can be identified. This can enable identification of corresponding code blocks, e.g., what code blocks correspond to high-utilization states. Accordingly, RECC 320 can generate a recommendation, e.g., embodied in recinfo 322, that can indicate a code block that can be a candidate for conversion to a serverless function. Where a code block is converted to a serverless function, the code block can be removed from future iterations of the executing code. As such, future executing code can call the serverless function rather than executing the code block, which can result in provisioning cloud resources more efficiently by not needing to preemptively provision typically less used cloud resources associated with the demand of executing the now removed code block because the replacement serverless function can be called on-demand and managed by the cloud computing environment independent of the application being run on the cloud system.

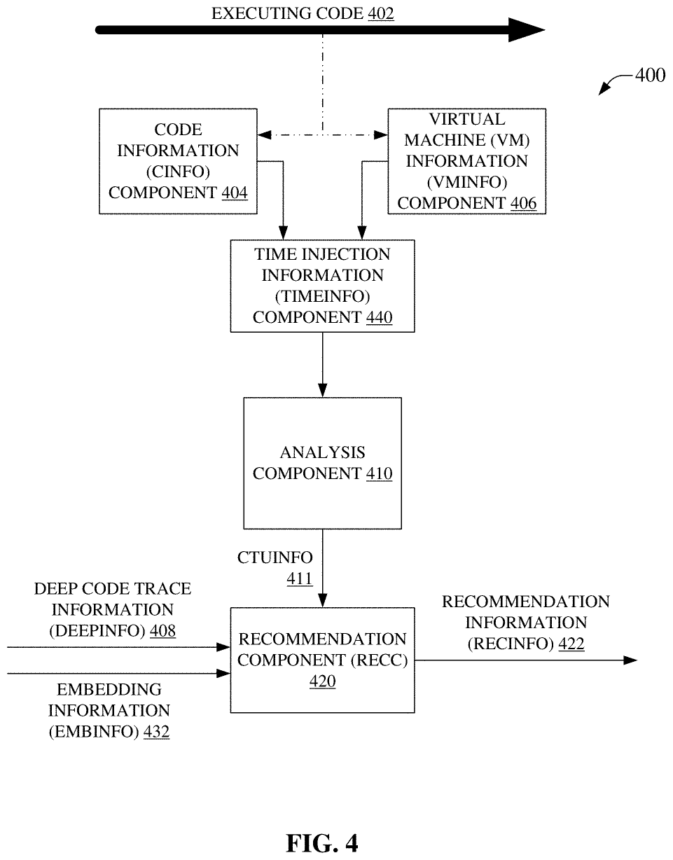

FIG. 4 is an illustration of a system 400, which can enable code architecture adaptation based on a code-to-utilization metric via determining recommendation information for a function, e.g., a candidate code block, etc., that can be a candidate for conversation to a serverless function, in accordance with aspects of the subject disclosure. System 400 can comprise executing code 402 that can be application source code, or a derivative thereof, that can be executed on processors comprised in a cloud computing environment, e.g., via a virtual machine (VM), server, computing cluster, or other embodiment of a real or virtual cloud computing device. The executing code 402 can be monitored by components of system 400, as illustrated by the broken-line arrows between executing code 402 and other components of system 400, e.g., cinfo component 404, vminfo component 406, etc.

Cinfo component 404 can monitor executing code 402 and can extract code information (cinfo), e.g., what code blocks are in execution, etc. In this regard, even if executing code 402 is, for example, assembly code in execution, cinfo component 404 can determine which code blocks are being executed at any point in the assembly code, e.g., cinfo component 404 can map any derivative of source code back to the source code to enable identification of code blocks being performed in executing code 402 running on a cloud platform component. Cinfo component 404 can generate cinfo that can be received, as illustrated, by time injection information (timeinfo) component 440.

Vminfo component 406 can also monitor executing code 402. Vminfo component 406 can generate vminfo that can indicate utilization of cloud computing resources, e.g., what cloud computing resources are being used and to what extent they are being used. Vminfo can be communicated from vminfo component 406 to timeinfo component 440, as illustrated.

Timeinfo component 440 can receive cinfo and vminfo that can be based on monitoring of executing code 402. Timeinfo component 440 can employ the cinfo and vminfo and inject timing information to create detailed logs identifying which blocks of code are running at a given time stamp in relation to cloud computing resource utilization metrics. This can result in timeinfo, e.g., combining time logs, code information, and utilization information, that can be communicated to analysis component 410. It is noted that, in some embodiments, timeinfo can be determined continuously and in a production environment, whereby it can be distinct from more conventional profiling tools that typically are not employed in production environments due to the instrumentation of code used, and higher levels of computing overhead needed to perform traditional code profiles.

Analysis component 410 can receive timeinfo from timeinfo component 440. Analysis component can generate code-to-utilization information (ctuinfo) 411 based on timeinfo. Ctuinfo 411 can be communicated towards recommendation component (RECC) 420. Analysis component 410 can be an autoencoder machine learning model that can ingest lightweight time-stamped logs, e.g., timeinfo, and that can identify which functions, candidate code blocks, etc., are running and can map them to VM hardware utilization logs, resulting in ctuinfo 411. Analysis component 410 can, in some embodiments, use one-off deep code traces provided by a standard source code profiler, e.g., deepinfo 308, for validation and tuning.

Ctuinfo 411 can be passed to RECC 420 that can generate recinfo 422. Recinfo 422 can embody an indication of a candidate code block that can be considered as a target for conversion to a serverless function. RECC 420 can determine recinfo 422 based on neural network as disclosed at numerous other portions of the instant disclosure. Embinfo 432, e.g., via code embedding component 230, etc., can represent mapped code blocks at points in a high-dimensional continuous space. Code blocks with similar behaviors and functionality can be collocated near each other in an embedding space. Among other uses, embinfo 432 can enables the clustering and identification of functionally similar modules of source code. RECC 420 can therefore include embinfo 432 in determining a code block(s) as a candidate(s) for conversation to a serverless function(s). Moreover, deepinfo 408 can be employed in training of the neural network that can identify a block of code that can be successfully migrated to a serverless function. Moreover, ctuinfo 411 can facilitate also estimating a potential cost savings for migration of blocks to serverless functions. As such, recinfo 422 generated by RECC 420 can comprise an indication of one or more code blocks that can be candidates for conversion to one or more serverless functions, estimated cost savings, and/or other information. In embodiments, the neural network can facilitate ranking of the one more code block conversions, e.g., recommending more strongly code blocks that would be more beneficial to convert to a serverless function than others, e.g., conversions predicted to result in greater cost savings, blocks that have more or closer embedding space neighbors, etc.

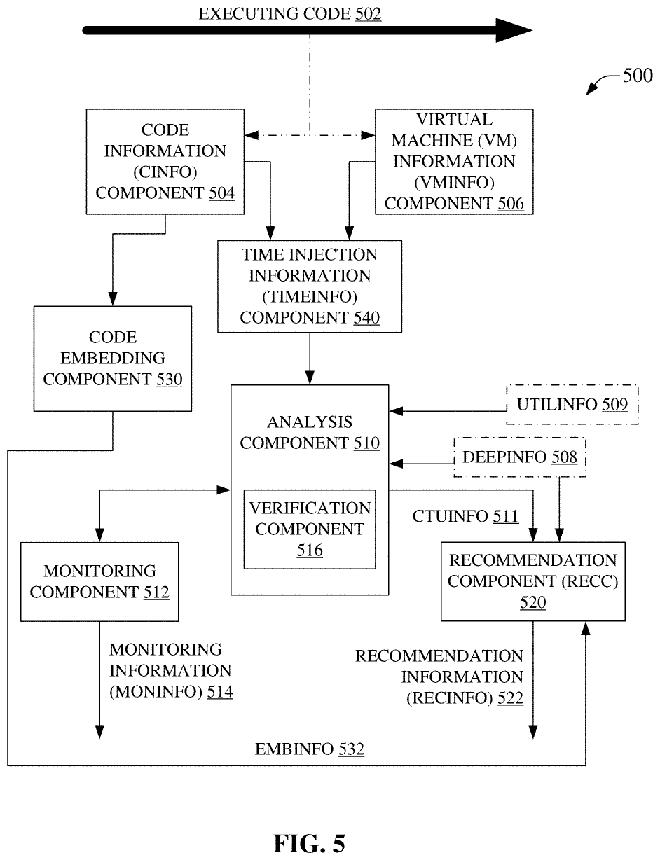

FIG. 5 is an illustration of a system 500, which can support code architecture adaptation based on determining a candidate serverless function corresponding to a code-to-utilization metric and code embedding information, in accordance with aspects of the subject disclosure. System 500 can comprise executing code 502 that can be application source code, or a derivative thereof, that can be executed on processors comprised in a cloud computing environment, e.g., via a virtual machine (VM), server, computing cluster, or other embodiment of a real or virtual cloud computing device. The executing code 502 can be monitored by components of system 500, as illustrated by the broken-line arrows between executing code 502 and other components of system 500, e.g., cinfo component 504, vminfo component 506, etc.

Cinfo component 504 can monitor executing code 502 and can extract code information (cinfo), e.g., what code blocks are in execution, etc. In this regard, even if executing code 502 is, for example, assembly code in execution, cinfo component 504 can determine which code blocks are being executed at any point in the assembly code, e.g., cinfo component 504 can map any derivative of source code back to the source code to enable identification of code blocks being performed in executing code 502 running on a cloud platform component. Cinfo component 504 can generate cinfo that can be received, as illustrated, by time injection information (timeinfo) component 540.

Vminfo component 506 can also monitor executing code 502. Vminfo component 506 can generate vminfo that can indicate utilization of cloud computing resources, e.g., what cloud computing resources are being used and to what extent they are being used. Vminfo can be communicated from vminfo component 506 to timeinfo component 540, as illustrated. In some embodiments, computing resource utilization information (utilinfo) 509 can be generated, for example by a VM logging component, such as VM logging component 207 of system 200, and can be substituted for, or supplementary to, vminfo from vminfo component 506. Accordingly, where system 500 does not comprise vminfo component 506, utilinfo 509 can be communicated to timeinfo component 540 as a substitute for vminfo. Further, system 500 can use vminfo from vminfo component 506 as a substitute for utilinfo 509 communicated to analysis component 510. In other embodiments, for example as illustrated in system 500, vminfo component 506 can communicate vminfo to timeinfo component 540 and utilinfo 509 can be received from another component, e.g., VM logging component 207, and be received at analysis component 510.

Timeinfo component 540 can receive cinfo and vminfo that can be based on monitoring of executing code 502. Timeinfo component 540 can employ the cinfo and vminfo and inject timing information to create detailed logs identifying which blocks of code are running at a given time stamp in relation to cloud computing resource utilization metrics. This can result in timeinfo, e.g., combining time logs, code information, and utilization information, that can be communicated to analysis component 510. It is noted that, in some embodiments, timeinfo can be determined continuously, in a production environment, etc., whereby it can be distinct from more conventional profiling tools that typically are not employed in production environments, are run as a stand-alone single analysis, etc., due to the instrumentation of code used, higher levels of computing overhead needed to perform traditional code profiles, etc.

Analysis component 510 can receive timeinfo from timeinfo component 540. Timeinfo can be verified against deepinfo 508, e.g., via verification component 516, that ensure that timeinfo is sufficiently accurate, e.g., deepinfo 508 can be conventional code profiling results that can be accepted as being a most accurate representation of code performance from a development environment. However, where deepinfo 508 is generally not generated in a production environment, it can be preferable to use timeinfo that can be generated in a production environment for determining ctuinfo 511, so long as timeinfo is sufficiently accurate to be relied on for these purposes. Accordingly, verifying timeinfo against deepinfo 508 can provide confidence that timeinfo is sufficiently accurate. Moreover, inaccuracies between timeinfo and deepinfo 508 can result in adjustment of timeinfo component 540 to improve the accuracy of generated timeinfo, e.g., verification component 516 can facilitate updating of timeinfo component 540 based on the verification of satisfactory accuracy of timeinfo in relation to deepinfo 508. Moreover, the verification operation can be performed sufficiently often to provide continued confidence in timeinfo, e.g., verification can be repeated at selected periods, intervals, times, or triggered, for example, by new deepinfo 508 becoming available, etc.

Analysis component can generate code-to-utilization information (ctuinfo) 511 based on timeinfo. In some embodiments, utilinfo 509 can also be employed in determining ctuinfo 511, e.g., utilinfo 509 can be substituted for vminfo where a cloud platform utilization component is selected to provide utilization information. Ctuinfo 511 can be communicated towards recommendation component (RECC) 520. Moreover, analysis component 510 can communicate with monitoring component 512, which can generate moninfo 514 that can be employed to render aspects of ctuinfo, for example, a plot of computing resource utilization in time, wherein selection of portions of the plot can facilitate identification of relevant code blocks that can correspond to levels of resource utilization of interest. In this example, a peak utilization can be selected to enable determining an identity of the code block(s) executing at the time of the peak utilization.

In system 500, cinfo from cinfo component 504 can be consumed by code embedding component 530. Code embedding component 530 can determine a numerical representation of source code modules/blocks that can be used for clustering and identification of functionally similar blocks of code in a high-dimensional continuous embedding space. As such, embedding information (embinfo) 532 can comprise an indication of groups of code blocks that can be functionally similar. Neighbors of a code block in an embedding space can therefore be selected based on how near they are to the code block, e.g., code blocks with high levels of similarity between their functionality can be closer in the embedding space than code blocks with lower levels of similarity between their functionalities. In this regard, recommendations for converting a code block into a serverless function, e.g., recinfo 522, etc., can be directed at code blocks that can be comprised in groups because the resulting serverless function can be more impactful via encompassing functionality of code blocks comprising the group of neighboring code blocks, e.g., as previously disclosed designing one serverless function to replace five code blocks with similar functionality in the embedding space can be viewed as being more favorable than designing five serverless functions to replace five code blocks with divergent functionality in the embedding space. However, it is again noted that, in this regard, where a code block corresponds to a sufficiently high-utilization of cloud resources, it can still be preferable to replace that code block even where it can have few, or even no, embedding space neighbors, notwithstanding favoring replacing high-utilization code blocks that do have neighbors still generally being considered a positive outcome.

As noted, ctuinfo 511 can be passed to RECC 520 that can generate recinfo 522. Recinfo 522 can embody an indication of a candidate code block that can be considered as a target for conversion to a serverless function. RECC 520 can determine recinfo 522 based on neural network, which can be trained in part based on deepinfo 508, etc. A neural network can enable determining a recommendation of a candidate code block for conversion to a serverless function. The recommendation can identify a candidate block of code, an estimated cost savings of converting the candite block to a serverless function for further operations, etc., e.g., costs saved by implementing the code block as a serverless function rather than maintain computing resource overhead for the code block before conversion to a serverless function. Embinfo 532 can be employed by RECC 520 in determining recinfo 522 to facilitate considerations of replacing groups of code blocks having similar functionality with a serverless function. In part, embinfo 532 and ctuinfo 511 can support ordering, sorting, ranking, etc., of candidates for conversion from application code block to serverless function. This ranking, sorting, ordering, etc., can be based on an inferred best cost savings, a predicted offloading of peak computing resource utilization, etc., for example. In embodiments, the neural network can be a classifier that can predict a likelihood of successfully re-architecting a block of code as a serverless function. This embodiment can include a heuristic that can estimate a cost savings based on the ctuinfo as disclosed herein. In other embodiments, the neural network can be a regression model that can predict a total cost savings of migrating a block of code to a serverless function, where a low or negative cost savings prediction can correspond to a code block that is less preferable, or should not be, converted to a serverless function. While in yet other embodiments, the neural network can be an embedding model that can perform unsupervised clustering that can collocate a block of code with similar properties in an embedding space and, in conjunction with ctuinfo, can expressively capture hardware utilization behaviors in a manner that is fundamentally different than purely syntactically defined embedding models. Expert knowledge can be applied to identify clusters of code blocks in an embedding space that can be good candidates for serverless functions. In these embodiments, ctuinfo can similarly be used to estimate cost savings for converting an application code block to a serverless function.

System 500 can illustrate, that executing code 502 can be monitored. The monitored code can be time logged to enable correlating execution of code blocks with resource utilization, e.g., as timeinfo. Timeinfo can be verified as being sufficiently accurate against deepinfo 508 via verification component 516. Inaccuracies between deepinfo 508 and timeinfo can be corrected for to ensure that timeinfo is sufficiently adequate to be relied on. Time info can then be analyzed, by analysis component 510 indicate what code is being executed at a given time and what corresponding computing resource utilization is occurring, e.g., as ctuinfo 511. Information related to the analysis can be rendered via monitoring component 512, e.g., based on moninfo 514, for example as a time-based plot of cloud resource utilization. Accordingly, high-utilization features can be identified. This can enable identification of corresponding code blocks, e.g., what code blocks correspond to high-utilization states. Code embedding component 530 can indicate to RECC 520 groups of code blocks that can have similar functionality to support batch replacement of code blocks. Accordingly, RECC 520 can generate a recommendation, e.g., embodied in recinfo 522, that can indicate a code block that can be a candidate for conversion to a serverless function. In embodiments, recinfo 522 can comprise ordered, sorted, ranked, filtering, etc., lists of code blocks that are recommended for conversion to serverless functions. The ranking, ordering, sorting, filtering, etc., can be based on selectable criteria such as predicted cost savings, predicted difficulty in converting to a serverless function, an inference relating to a reduction in provisioned computing resources by migrating code to a serverless function, expectations of efficiency in converting a group of neighboring embedding space code blocks into a serverless function, etc. Where a code block is converted to a serverless function, the code block can be removed from future iterations of the executing code. As such, future executing code can call the serverless function rather than executing the code block, which can result in provisioning cloud resources more efficiently by not needing to preemptively provision typically less used cloud resources associated with the demand of executing the now removed code block because the replacement serverless function can be called on-demand and managed by the cloud computing environment independent of the application being run on the cloud system.

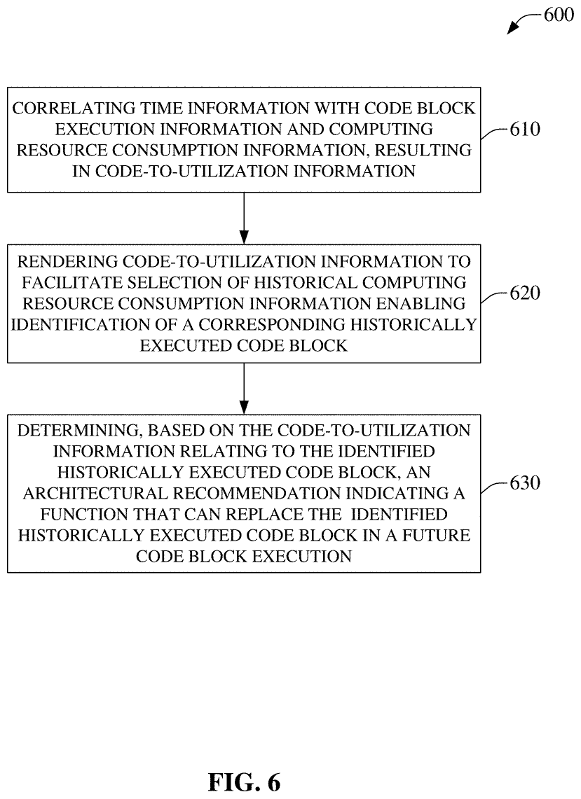

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, which can facilitate code architecture adaptation based on rendering a code-to-utilization metric to facilitate identifying a function, candidate code block, etc., that can be a candidate for conversation to a serverless function, in accordance with aspects of the subject disclosure. At 610, method 600 can comprise correlating time information with code block execution information and computing resource consumption information, resulting in code-to-utilization information (ctuinfo). Time information can be injected, for example, via timeinfo component 340, 440, 540, etc. Correlation can relate code blocks in execution with a time and with computing resources being utilized, which can provide an understanding of what code blocks can result in high levels of computing resource utilization. These high-utilization code blocks can be considered for conversion to a serverless function. Where code blocks are converted to serverless functions, the functionality of the code block can be retained but performed via a function call as a FaaS supported by a cloud platform provider rather than being retained in application code that is provisioned via the cloud service. As such, the serverless function can result in provisioning fewer computing resources than where the code block is retained in executable application code, thereby reducing cost of providing an application via a cloud platform.

Method 600, at 620, can comprise rendering code-to-utilization information to facilitate selection of historical computing resource consumption information enabling identification of a corresponding historically executed code block. Rendering ctuinfo, for example as a running plot of computing resource utilization in time, can facilitate identifying corresponding code blocks. As an example, a user can select a high-utilization portion of rendered ctuinfo to identify a code block(s) corresponding to the high-utilization of computing resources. Moreover, the high-utilization can be readily distinguished from more general levels of utilization, e.g., as peaks in an example plot of utilization over time. Additionally, the degree of utilization, e.g., the height of a utilization peak, can be readily appreciated by a user, further enabling ready selection of more prominent utilization peaks and an accompanying identification of related code blocks to facilitate selection of candidates for conversation to serverless functions.

At 630, method 600 can comprise determining, based on the code-to-utilization information relating to the identified historically executed code block, an architectural recommendation indicating a function that can replace the identified historically executed code block in a future code block execution. At this point, method 600 can end. An architectural recommendation can be a recommendation relating to changing code to be executed in support of an application deployed via a cloud platform. Where high-utilization can result from some code blocks, and where provisioning for application code generally would include provisioning for high-utilization, converting high-utilization code blocks to serverless functions can reduce an amount of cloud computing resources that are provisioned in anticipation of overall computing resource utilization levels, e.g., removing the peak utilization code blocks to serverless functions can result in provisioning fewer resources to perform the application via the cloud platform by employing serverless functions in lieu of the high-utilization code blocks where the serverless functions can be called, scaled, managed, etc. by the cloud provider independent of the application code provisioning.

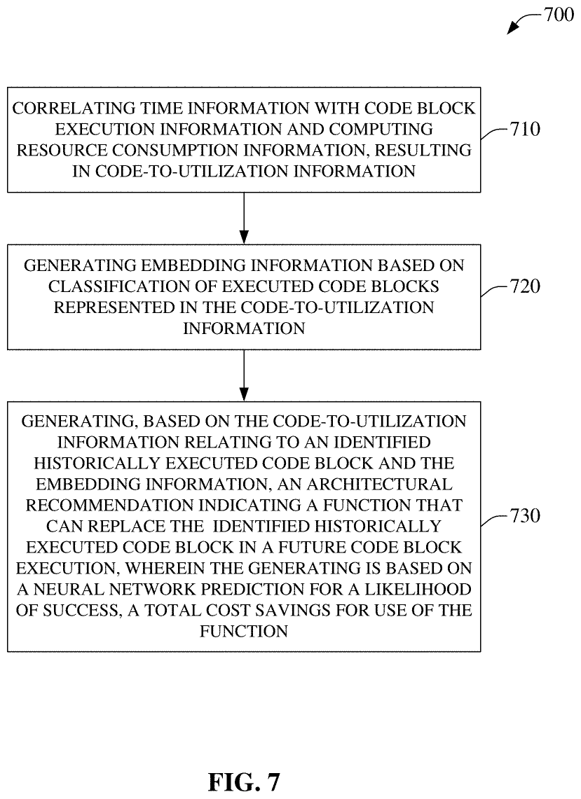

FIG. 7 illustrates example method 700 that facilitates code architecture adaptation based on a code-to-utilization metric determined in part from time injection information to facilitate identifying a function, candidate code block, etc., that can be a candidate for conversation to a serverless function, in accordance with aspects of the subject disclosure. Method 700, at 710, can comprise correlating time information with code block execution information and computing resource consumption information, resulting in code-to-utilization information (ctuinfo). Time information can be injected, for example, via timeinfo component 340, 440, 540, etc. Correlation can relate code blocks in execution with a time and with computing resources being utilized, which can provide an understanding of what code blocks can result in high levels of computing resource utilization. These high-utilization code blocks can be considered for conversion to a serverless function. Where code blocks are converted to serverless functions, the functionality of the code block can be retained but performed via a function call as a FaaS supported by a cloud platform provider rather than being retained in application code that is provisioned via the cloud service. As such, the serverless function can result in provisioning fewer computing resources than where the code block is retained in executable application code, thereby reducing cost of providing an application via a cloud platform.

Method 700, at 720, can comprise generating embedding information (embinfo) based on classification of executed code blocks represented in the code-to-utilization information. Embinfo can be generated, for example, by code embedding component 230, 530, etc. Embinfo can facilitate determining code blocks that can have similar behaviors and/or functionality by collocating code blocks in an embedding space that can be a high-dimensional continuous space of points for mapping blocks of source code, e.g., similar code blocks can occur as near neighbors in embedding space while dissimilar code blocks can be spaced farther apart in the embedding space. Accordingly, groups of code blocks that can occur near to each other in the embedding space can, in some instances, be replaced with fewer serverless functions than distant individual code blocks in the embedding space, e.g., a serverless function can be generated that can embody the functionality of more than one code block that can be part of a group of neighboring code blocks in the embedding space. As such, an identified high-utilization code block can be identified in the embedding space to enable identification of neighbor code blocks in the embedding space, whereby the high-utilization code block and neighboring code blocks can be preferred candidates for conversion to a serverless function, particularly where the serverless function can capture functionality of close embedding space neighbors. Embinfo can enable more efficient use of application developer time than, for example, failing to identify neighboring code blocks and instead developing two serverless functions that, according to the embedding space can have similar behaviors and functionality. Embinfo can be based on creation of numerical representations of source code modules/blocks that can be used for clustering and identification of functionally similar blocks of code in the high-dimensional continuous embedding space.

At 730, method 700 can comprise generating, based on the code-to-utilization information relating to an identified historically executed code block and the embedding information, an architectural recommendation indicating a function, candidate code block, etc., that can replace the identified historically executed code block in a future code block execution, wherein the generating is based on a neural network prediction for a likelihood of success, a total cost savings for use of the function, candidate code block, etc. At this point, method 700 can end. As disclosed herein, an architectural recommendation can be a recommendation relating to changing code to be executed in support of an application deployed via a cloud platform. Where high-utilization can result from some code blocks, and where provisioning for application code generally would include provisioning for high-utilization, converting high-utilization code blocks to serverless functions can reduce an amount of cloud computing resources that are provisioned in anticipation of overall computing resource utilization levels, e.g., removing the peak utilization code blocks to serverless functions can result in provisioning fewer resources to perform the application via the cloud platform by employing serverless functions in lieu of the high-utilization code blocks where the serverless functions can be called, scaled, managed, etc. by the cloud provider independent of the application code provisioning. Moreover, identifying groups of code blocks in embedding space can facilitate recommendation that allow for serverless functions to replace more than one block of code that can have similar functionality. In some embodiments, sorting, ranking, ordering, filtering, etc., can be employed to preferably recommend more impactful conversations to serverless functions, e.g., recommending a conversation that can replace a group of code blocks having similar functionality and therefore being neighbors in the embedding space can be more impactful than recommending conversion of more isolated code blocks from the embedding space. This ranking, ordering, sorting, filtering, etc., can also be considerate of levels of utilization, e.g., via ctuinfo, for code blocks, such that, for example a group of code blocks from embedding space can be less impactful than converting a solo code block that has a more substantial impact on resource utilization than the group of code blocks.

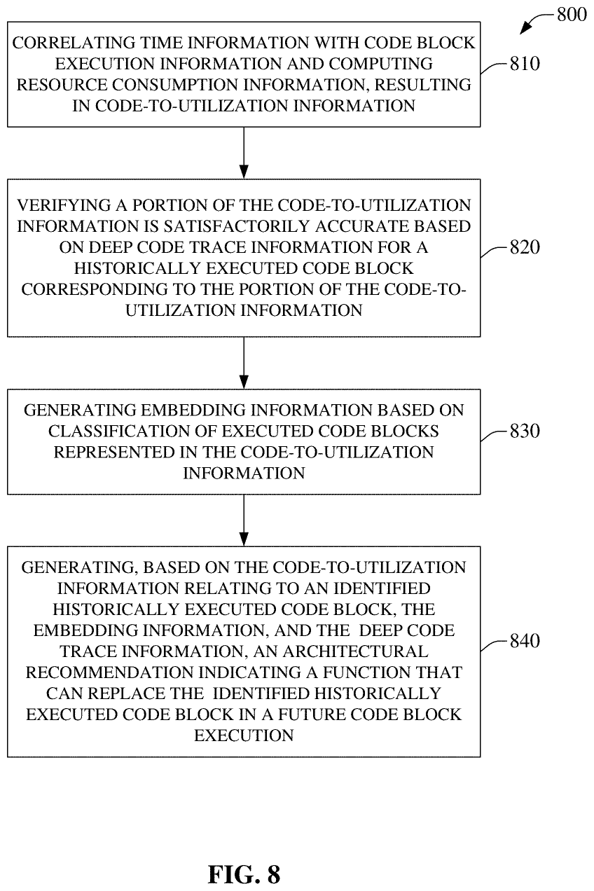

FIG. 8 illustrates example method 800 enabling code architecture adaptation based on a code-to-utilization metric determined in part from time injection information to facilitate identifying a function, candidate code block, etc., that can be a candidate for conversation to a serverless function, wherein the time injection information can be verified based on deep code trace information, in accordance with aspects of the subject disclosure. Method 800, at 810, can comprise correlating time information with code block execution information and computing resource consumption information, resulting in code-to-utilization information (ctuinfo). Time information can be injected, for example, via timeinfo component 340, 440, 540, etc. Correlation can relate code blocks in execution with a time and with computing resources being utilized, which can provide an understanding of what code blocks can result in high levels of computing resource utilization. These high-utilization code blocks can be considered for conversion to a serverless function. Where code blocks are converted to serverless functions, the functionality of the code block can be retained but performed via a function call as a FaaS supported by a cloud platform provider rather than being retained in application code that is provisioned via the cloud service. As such, the serverless function can result in provisioning fewer computing resources than where the code block is retained in executable application code, thereby reducing cost of providing an application via a cloud platform.

Method 800, at 820, can comprise verifying a portion of the code-to-utilization information is satisfactorily accurate based on deep code trace information for a historically executed code block corresponding to the portion of the code-to-utilization information. As noted elsewhere herein, a conventional code profile, for example performed during application development or testing, can be considered highly accurate even though the conventional code profile cannot typically be performed continuously in a production environment, e.g., where the code is deployed and in execution it can be impractical to perform conventional code tracing. Whereas timeinfo can be performed in a production environment, use of timeinfo to identify code blocks that can cause high computing resource utilization levels can be desirable, so long as the timeinfo can be considered as sufficiently accurate. Accordingly, deepinfo, e.g., code block information from a conventional code trace, such as can be performed by code profiling component 205, etc., can be used to verify that timeinfo is sufficiently accurate. Deepinfo can be compared to timeinfo to determine a level of coherence. Where the level of coherence satisfies an accuracy rule relating to a selectable level of accuracy between deepinfo and timeinfo, the timeinfo can be verified as being sufficiently accurate. Where the timeinfo is not verified, generating timeinfo can be adapted to improve the accuracy of future timeinfo.

At 830, method 800, can comprise generating embedding information (embinfo) based on classification of executed code blocks represented in the code-to-utilization information. Embinfo can be generated, for example, by code embedding component 230, 530, etc. Embinfo can facilitate determining code blocks that can have similar behaviors and/or functionality by collocating code blocks in an embedding space that can be a high-dimensional continuous space of points for mapping blocks of source code, e.g., similar code blocks can occur as near neighbors in embedding space while dissimilar code blocks can be spaced farther apart in the embedding space. Accordingly, groups of code blocks that can occur near to each other in the embedding space can, in some instances, be replaced with fewer serverless functions than distant individual code blocks in the embedding space, e.g., a serverless function can be generated that can embody the functionality of more than one code block that can be part of a group of neighboring code blocks in the embedding space. As such, an identified high-utilization code block can be identified in the embedding space to enable identification of neighbor code blocks in the embedding space, whereby the high-utilization code block and neighboring code blocks can be preferred candidates for conversion to a serverless function, particularly where the serverless function can capture functionality of close embedding space neighbors. Embinfo can enable more efficient use of application developer time than, for example, failing to identify neighboring code blocks and instead developing two serverless functions that, according to the embedding space can have similar behaviors and functionality. Embinfo can be based on creation of numerical representations of source code modules/blocks that can be used for clustering and identification of functionally similar blocks of code in the high-dimensional continuous embedding space.

Method 800, at 840, can comprise generating, based on the code-to-utilization information relating to an identified historically executed code block and the embedding information, an architectural recommendation indicating a function, candidate code block, etc., that can replace the identified historically executed code block in a future code block execution, wherein the generating is based on a neural network prediction for a likelihood of success, a total cost savings for use of the serverless function. At this point, method 800 can end. As disclosed herein, an architectural recommendation can be a recommendation relating to changing code to be executed in support of an application deployed via a cloud platform. Where high-utilization can result from some code blocks, and where provisioning for application code generally would include provisioning for high-utilization, converting high-utilization code blocks to serverless functions can reduce an amount of cloud computing resources that are provisioned in anticipation of overall computing resource utilization levels, e.g., removing the peak utilization code blocks to serverless functions can result in provisioning fewer resources to perform the application via the cloud platform by employing serverless functions in lieu of the high-utilization code blocks where the serverless functions can be called, scaled, managed, etc. by the cloud provider independent of the application code provisioning. Moreover, identifying groups of code blocks in embedding space can facilitate recommendation that allow for serverless functions to replace more than one block of code that can have similar functionality. In some embodiments, sorting, ranking, ordering, filtering, etc., can be employed to preferably recommend more impactful conversations to serverless functions, e.g., recommending a conversation that can replace a group of code blocks having similar functionality and therefore being neighbors in the embedding space can be more impactful than recommending conversion of more isolated code blocks from the embedding space. This ranking, ordering, sorting, filtering, etc., can also be considerate of levels of utilization, e.g., via ctuinfo, for code blocks, such that, for example a group of code blocks from embedding space can be less impactful than converting a solo code block that has a more substantial impact on resource utilization than the group of code blocks.

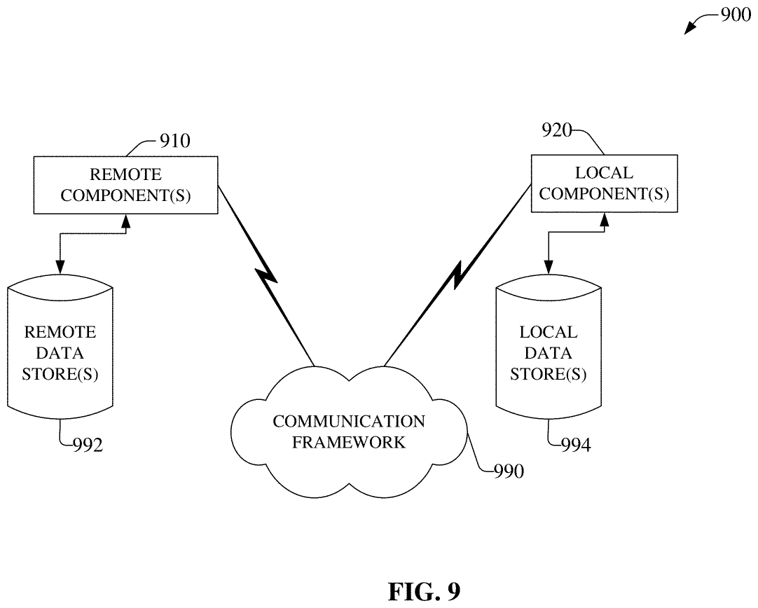

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can comprise analysis component 110, 310-510, etc., monitoring component 112, 312, 512, etc., recommendation component 120, 320-520, etc., time injection component 340-540, etc., code information component 304-504, etc., virtual machine information component 306-506, etc., code information component 204, etc., code profiling component 205, etc., virtual machine logging component 207, etc., data store(s) 992, 994, etc., or any other component that is located remotely from another component of systems 100-500, etc.

The system 900 also comprises one or more local component(s) 920. The local component(s) 920 can be hardware and/or software (e.g., threads, processes, computing devices). In some embodiments, local component(s) 920 can comprise analysis component 110, 310-510, etc., monitoring component 112, 312, 512, etc., recommendation component 120, 320-520, etc., time injection component 340-540, etc., code information component 304-504, etc., virtual machine information component 306-506, etc., code information component 204, etc., code profiling component 205, etc., virtual machine logging component 207, etc., data store(s) 992, 994, etc., or any other component that is located local with another component of systems 100-500, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 990 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 992, such as a hard drive, solid state drive, SIM card, device memory, etc., that can be employed to store information on the remote component(s) 910 side of communication framework 990. Similarly, local component(s) 920 can be operably connected to one or more local data store(s) 994, that can be employed to store information on the local component(s) 920 side of communication framework 990. As examples, timeinfo, deepinfo, recinfo, moninfo, utilinfo, embinfo, etc., or other information that can facilitate recommending a code block for conversion to a serverless function, can be stored on a local data store 994, etc., or remote data store 992, etc., and be communicated between components of systems 100-500 via communication framework 990, etc.

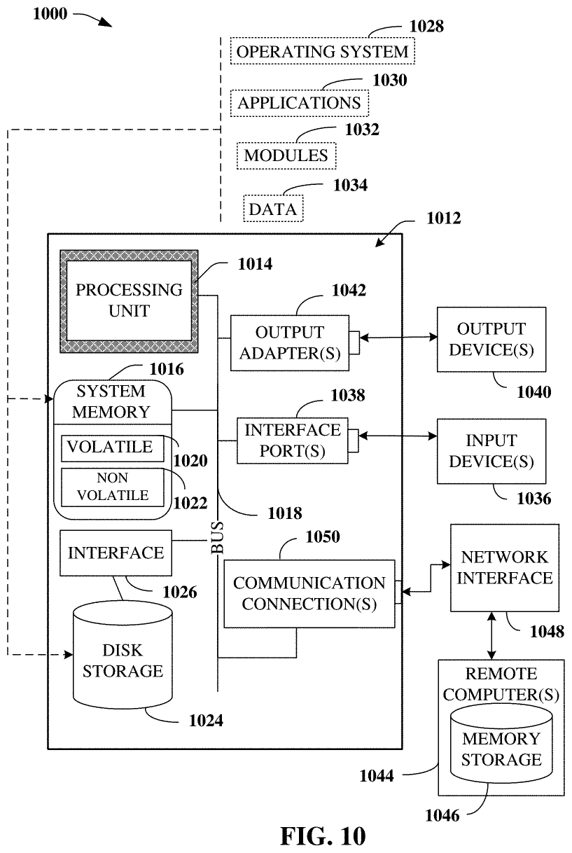

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random-access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in network core component 110-510, etc., RAN component 120, 320-520, etc., AP component 120-520, etc., data store(s) 592, 992, 994, etc., UE 102, 104, etc., or any other component that is located local with another component of systems 100-500, etc., can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random-access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory, or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory, or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries, or other data retrieval protocols, for a variety of operations with respect to the information stored by the medium. As such, for example, a computer-readable medium can comprise executable instructions stored thereon that, in response to execution, can cause a system comprising a processor to perform operations comprising identifying code blocks being executed at a remotely located processor and correlating the code blocks with computing resource utilization measurements and execution time values, resulting in code-to-utilization information as a function of time. A representation of the code-to-utilization information can be displayed to enable identification of a high-utilization code block of the code blocks. A recommendation to convert the high-utilization code block to a serverless function can be determined based on a predicted cost savings associated with implementing the serverless function in future execution of the code blocks without the high-utilization code block.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line-controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring, and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to authenticating a user-identity to a user-account. Authentication can, in some embodiments, refer to determining whether a user-identity requesting a service from a telecom network is authorized to do so within the network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); sixth generation partnership project (6G or 6GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer”, or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
identifying a code block being executed at a remotely located processor based on monitoring of code in execution; and
determining a recommendation to convert the code block to a serverless function based on a level of computing resource utilization corresponding to the code block being executed.

2. The device of claim 1, wherein the monitoring of code in execution comprises injecting a time log statement, resulting in code-to-utilization information that facilitates identifying a time at which the code block is executing in correlation with the level of computing resource utilization.

3. The device of claim 2, wherein the operations further comprise rendering the code-to-utilization information at a user device.

4. The device of claim 3, wherein the code-to-utilization information at a user device results in visually displaying a plot of computing resource utilization as a function of time, and wherein selection of a portion of the plot indicates code blocks being executed in the portion of the plot selected.

5. The device of claim 1, wherein the operations further comprise locating the code block in an embedding space enabling clustering and identification of functionally similar blocks of code.

6. The device of claim 5, wherein the embedding space is a multi-dimensional continuous space, and wherein code blocks with similar functionality are collocated near each other in the embedding space.

7. The device of claim 5, wherein recommendations to convert code blocks comprises the recommendation to covert the code block, and wherein the recommendations to convert code blocks are ordered based on the clustering of functionally similar blocks of code in the embedding space.

8. The device of claim 1, wherein the operations further comprise determining that the identifying of the code block satisfies an accuracy rule based on deep code trace information, wherein the identifying of the code block is performed in a production computing environment, and wherein the deep code trace information is not determined in a production computing environment.

9. The device of claim 8, wherein the accuracy rule is based on a selectable level of coherence between the deep code trace information and the identifying of the code block.

10. The device of claim 8, wherein a code information component, which determines an identity of the code block via the monitoring of the code in execution, is updated in response to determining that the identifying of the code block does not satisfy the accuracy rule, resulting in an adapting of future iterations of the identifying of the code block to have improved accuracy.

11. The device of claim 1, wherein converting the code block to a serverless function in accord with the recommendation results in removing the code block from application code based on substituting the code block with a call to the serverless function.

12. The device of claim 1, wherein recommendations to convert code blocks comprises the recommendation to covert the code block, and wherein the recommendations to convert code blocks are ordered based on a predicted cost savings corresponding to the recommendation to convert the code block to the serverless function.

13. A method, comprising:
monitoring, by a system comprising a processor, executing code to identify code blocks being executed at a remotely located processor;
injecting, by the system, time statements with corresponding identified code blocks and corresponding computing resource utilization measurements, resulting in code-to-utilization information as a function of time; and
determining, by the system, a recommendation to convert a code block of the code blocks to a serverless function based on a computing resource utilization measurement of the computing resource utilization measurements, wherein the computing resource utilization measurement corresponds to the code block.

14. The method of claim 13, wherein the operations further comprise ordering, by the system, recommendations comprising the recommendation based on a predicted cost savings associated with future code execution employing the serverless function as a substitute for the code block.

15. The method of claim 13, wherein the operations further comprise determining, by the system, code embedding information corresponding to the code block, wherein the embedding information corresponds to mapping the code block into a multi-dimensional continuous space based on a functionality of the code block.

16. The method of claim 15, wherein the mapping of the code block enables clustering of other code blocks that are functionally similar to the block of code, and wherein the operations further comprise ordering, by the system, recommendations comprising the recommendation based on clustering information that is comprised in the embedding information.

17. A non-transitory machine-readable storage medium, comprising executable instructions that, when executed by a processor, facilitate performance of operations, comprising:
identifying code blocks being executed at a remotely located processor;
correlating the code blocks with computing resource utilization measurements and execution time values, resulting in code-to-utilization information as a function of time;
displaying a representation of the code-to-utilization information to enable identification of a high-utilization code block of the code blocks according to a high-utilization criterion; and
determining a recommendation to convert the high-utilization code block to a serverless function based on a predicted cost savings associated with implementing the serverless function in future execution of the code blocks without the high-utilization code block.

18. The non-transitory machine-readable storage medium of claim 17, wherein the operations further comprise determining code embedding information representing a mapping of the code blocks into multi-dimensional continuous space based on functionalities of the code blocks.

19. The non-transitory machine-readable storage medium of claim 17, wherein the high-utilization code block is comprised in a cluster of other code blocks determined to be functionality similar based on the code embedding information.

20. The non-transitory machine-readable storage medium of claim 17, wherein the operations further comprise verifying that the identifying of the code blocks satisfies a selectable accuracy threshold based on deep code tract information received from a code profiler performing code analysis in a code development environment that is a different code environment than a code production environment supporting the identifying of the code blocks.
